(19) United States
(12) Patent Application Publication
(10) Pub. No.: US 2023/0236937 A1
(43) Pub. Date: Jul. 27, 2023

(54) COORDINATED CYCLING CYBER PROTECTION MANAGERS AND REPOSITORIES

(71) Applicant: International Business Machines Corporation, Armonk, NY (US)

(72) Inventors: Paolo Vitali, Saint-Clement-de-Riviere (FR); Axel Ligny, Prades le Lez (FR); Terry O'Connor, High Peak (GB)

(21) Appl. No.: 17/648,597

(22) Filed: Jan. 21, 2022

(51) Int. Cl. G06F 11/14

(52) U.S. Cl. CPC G06F 11/1464; G06F 11/1451; G06F 2201/84

(57) ABSTRACT

Disclosed are techniques for coordinating distributed backup data protection sites for alternating recording of point in time copies. For a monitored volume, or pool of monitored volumes, periodic point in time copies are recorded upon data storage capabilities of rotating backup data storage sites as each period elapses. Upon recording a point in time copy at a given backup data storage site, the given site broadcasts to other sites metadata about the point in time copies recorded by each of the backup data storage sites for the monitored volume. As subsequent periods elapse, a rotation of sites are cycled through for selection to record point in time copies for the given period such that point in time copies of the monitored volume are recorded across multiple backup data storage sites, with each backup data storage site recording point in time copies of the monitored volume snapshotted to different times.

### BACKGROUND

The present invention relates generally to the field of electronic data protection schemes, and more particularly to coordinating multiple cyber protection managers.

A point-in-time snapshot is a copy of a storage volume, file or database as it existed at a given point in time and are used as method of data protection. When a failure occurs, users can restore their data from the most recent snapshot before the failure.

A Recovery Point Objective (RPO) is typically determined by business continuity planning. RPO describes the maximum targeted period in which data (transactions) might be lost from an IT service due to a major incident. If an RPO is measured in minutes (or even a few hours), then in typical practice, off-site mirrored backups must be nearly continuously maintained; a daily off-site backup on tape will be insufficient.

### SUMMARY

According to an aspect of the present invention, there is a method, computer program product and/or system that performs the following operations (not necessarily in the following order): (i) monitoring a volume at a first data storage site for periodic point in time copying, where periodic point in time copying includes recording snapshots of the volume at specified times separated by a specified period of time; and (ii) periodically storing a point in time copy of the volume within data storage repositories of a subset of backup data storage site(s) selected from a set of backup data storage sites, where the set of backup data storage sites includes at least two backup data storage sites and the subset selected for storing the point in time copy is selected each period from a cycle of subsets of the set of backup data storage sites.

According to an aspect of the present invention, there is a method, computer program product and/or system that performs the following operations (not necessarily in the following order): (i) mirroring at least one data volume(s) to a set of data protection sites; and (ii) coordinating the set of data protection sites to record isolated copies of the mirrored at least one data volume(s), where data protection sites record isolated copies of the at least one data volume(s) from their local mirror of the at least one data volume(s) according to their respective schedules.

According to an aspect of the present invention, there is a method, computer program product and/or system that performs the following operations (not necessarily in the following order): (i) receiving, by a backup data site, a metadata dataset including information corresponding to a plurality of isolated backup copies of a data volume distributed among a plurality of coordinated backup data sites, where the metadata dataset includes information indicative of when each isolated backup copy was recorded and which coordinated backup data site recorded each isolated copy; (ii) receiving, by the backup data site, a copy of the data volume according to a set of mirroring protocols; (iii) receiving, by the backup data site, a schedule for isolated copy operations for the data volume; (iv) recording, by the backup data site, isolated copies of the data volume according to the received schedule; and (v) responsive to recording an isolated copy of the data volume according to the received schedule, broadcasting, by the backup data site, an updated metadata dataset to at least some of the coordinated backup data sites, with the updated metadata dataset including the received metadata dataset with additional information indicative of when the isolated copy was recorded and a corresponding location for the isolated copy indicative of data storage associated with the backup data site.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5A is a block diagram of a typical isolated cyber protection environment;

FIG. 5B is a block diagram of typical isolated cyber protection environment during a site failure;

FIG. 6 is a block diagram view of a second system according to the present invention; and

FIG. 7 is a screenshot view generated by the second embodiment system.

### DETAILED DESCRIPTION

Some embodiments of the present invention are directed to techniques for coordinating distributed backup data protection sites for alternating recording of point in time copies. For a monitored volume, or pool of monitored volumes, periodic point in time copies are recorded upon data storage capabilities of rotating backup data storage sites as each period elapses. Upon recording a point in time copy at a given backup data storage site, the given site broadcasts to other sites metadata about the point in time copies recorded by each of the backup data storage sites for the monitored volume. As subsequent periods elapse, a rotation of sites are cycled through for selection to record point in time copies for the given period such that point in time copies of the monitored volume are recorded across multiple backup data storage sites, with each backup data storage site recording point in time copies of the monitored volume snapshotted to different times. This Detailed Description section is divided into the following subsections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium (sometimes referred to as “machine readable storage medium”) can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be any thing made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

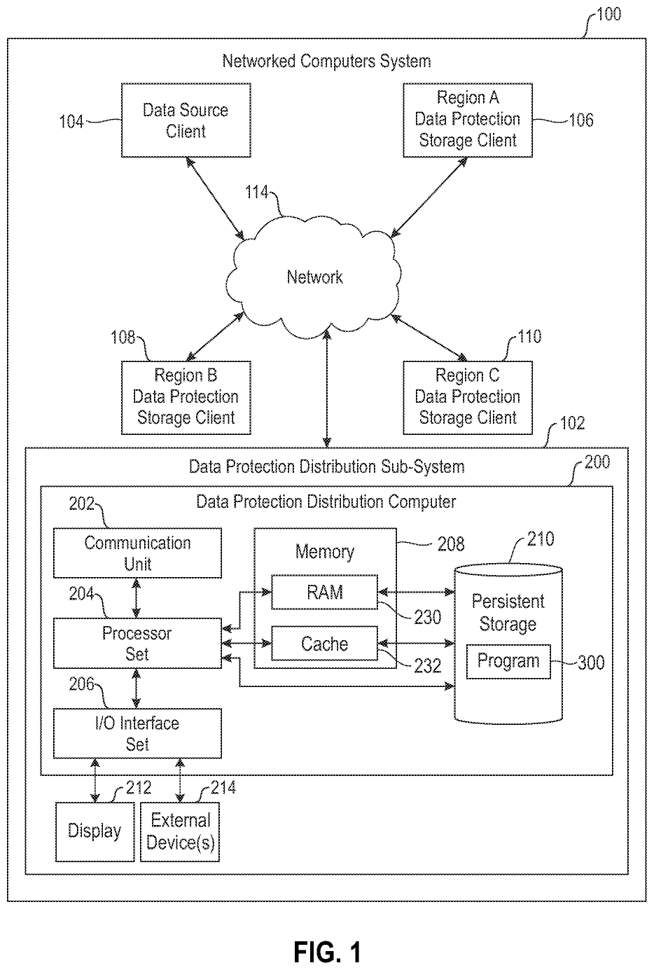

As shown in FIG. 1, networked computers system 100 is an embodiment of a hardware and software environment for use with various embodiments of the present invention. Described in detail with reference to the Figures. Networked computers system 100 includes: data protection distribution subsystem 102 (sometimes herein referred to, more simply, as subsystem 102); data source client 104; region A data protection storage client 106; region B data protection storage client 108; region C data protection storage client 110; and communication network 114. Subsystem 102 includes: data protection distribution computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

Data source client 104 is a client computer where a primary volume is sourced from for monitoring. The primary volume is then synchronously mirrored on region A data protection storage client 106 and asynchronously mirrored on region B data protection storage client 108, where synchronous mirroring indicates that the mirrored volume maintains an exact copy of the data in the primary volume in real time, and asynchronous mirroring indicates periodically refreshing the mirrored copy to match the primary volume. Asynchronous mirroring typically completes within seconds or minutes of updates to the primary volume, as opposed to updating the primary volume and other mirrored volumes in real time.

When using synchronous data transfer, application writes are first written to the primary disk subsystem and then forwarded on to secondary disk subsystems. When the data has been committed to both the primary and secondary disks, an acknowledgment that the write is complete is sent to the application. With asynchronous replication, the application writes to the primary disk subsystem and receives an acknowledgment that the I/O is complete as soon as the write is committed on the primary disk. The write to the secondary disk subsystems are completed in the background. Because applications do not have to wait for the completion of the I/O to the secondary subsystems, asynchronous solutions can be used at virtually unlimited distances with negligible impact to application performance.

The primary volume and any mirrored copies may be a logical data partition distributed across one or more computer readable storage media and comprise one or more datasets.

Region A data protection storage client 106, region B data protection storage client 108, and region C data protection storage client 110 are each client computers configured for storing copies of electronic data, such as the primary volumes, for cyber protection purposes, respectively located in different geographic regions, connected together (as well as to data source client 104 and subsystem 102) via network 114. Each data protection storage client has their own data protection distribution subsystem (not shown) similar to data protection distribution subsystem 102, which data protection distribution subsystem 102 communicates with.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

II. EXAMPLE EMBODIMENT

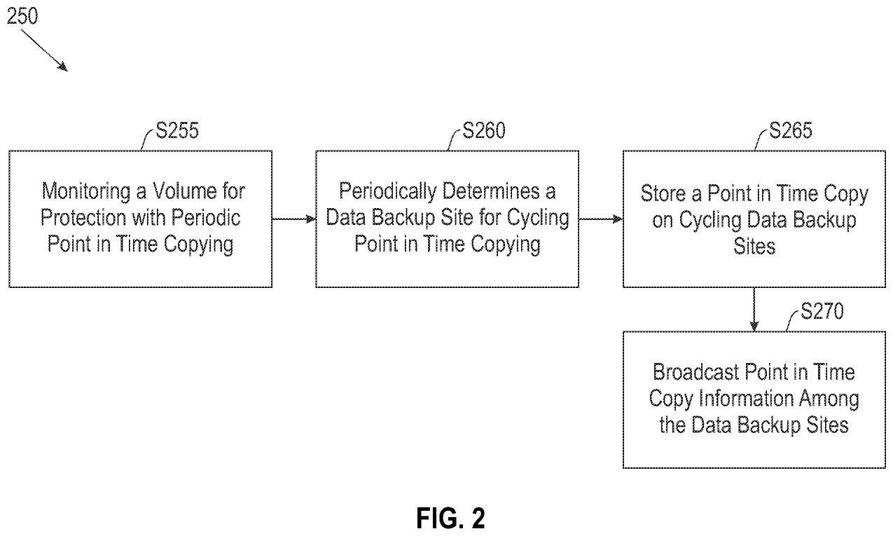

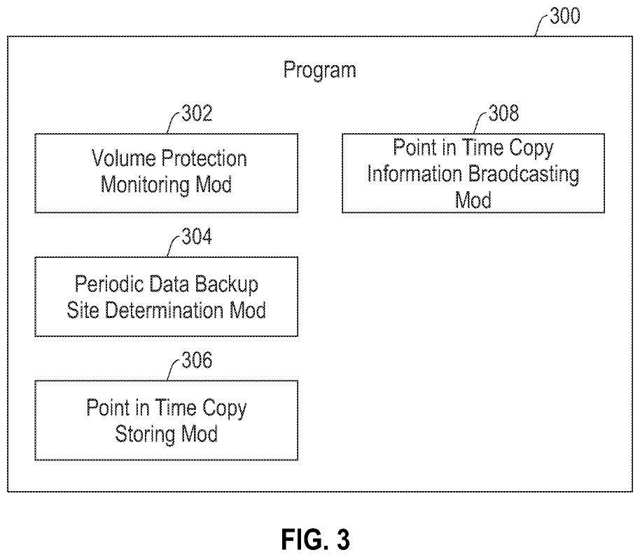

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

Processing begins at operation S255, where volume protection monitoring module (“mod”) 302 monitors a volume for protection with periodic point in time copying. In this simplified embodiment, the volume for protection with point in time copying is a data partition containing a database of transactions for a large e-commerce enterprise (“Example Enterprise”). Every customer transaction is recorded in the volume (hereafter referred to as the “primary volume”) as it occurs. This primary volume is recorded on storage devices of data source client 104. Data source client 104 is located at a first site, site 1, in region A, with region A corresponding to the metropolitan area of City A. Also located within City A is another site, site 2, which hosts region A data protection storage client 106. The primary volume is of critical importance to Example Enterprise and has been flagged for frequent point in time snapshots (or point in time copies) to be recorded, with one point in time copy being recorded for data protection at least every hour. This stipulation requires that a complete copy of the primary volume must be recorded at a data backup site at least once per hour, which indicates that aside from the primary volume there must be a copy of the primary volume recorded in at least one data backup site that is no more than an hour older than the primary volume. Additionally, the primary volume is synchronously mirrored on region A data protection storage client 106, and asynchronously mirrored once per day on region B data protection storage client 108.

Processing proceeds to operation S260, where periodic data backup site determination mod 304 periodically determines a data backup site for cycling point of time copying. In this simplified embodiment, there are three data backup sites that are available for receiving point in time copies of the primary volume: (i) region A data protection storage client 106; (ii) region B data protection storage client 108; and (iii) region C data protection storage client 110. As the primary volume has been flagged for hourly point in time copies, the period for periodic data backup site determination mod 304 is one hour; once an hour, periodic data backup site determination mod 304 determines a data backup site for cycling point in time copying. For determining which backup data site to use for a given periodic point in time copy, periodic data backup site determination mod 304 cycles through a sequence: (i) region A data protection storage client 106; (ii) region B data protection storage client 108; (iii) region C data protection storage client 110; and (iv) back to region A data protection client 104.

Once a point in time copy of the primary volume has been stored at one of the data protection sites, periodic data backup site determination mod 304 will select the next data protection site in the sequence, cycling which data protection site records a copy of the primary volume for any given period. After three periods have elapsed, for example, there will be three point in time copies of the primary volume spread across the three data backup sites: (i) one copy at t minus two hours recorded in region A data protection storage client 106; (ii) one copy at t minus one hours recorded in region B data protection storage client 108; and (iii) one copy at time t recorded in region C data protection storage client. In this simplified embodiment, five hours have passed since the monitoring of 5255 has been initiated, where following the sequence outlined above, periodic data backup site determination mod 304 will select region B data protection storage client 108 as the next client in the sequence. Thus far, the sequence in this simplified embodiment proceeded as follows: (i) monitoring was initiated on the primary volume on data source client 104 at time T; (ii) at T plus one hour, a point in time copy of the primary volume was recorded on region A data protection storage client 106 from the primary volume on data source client 104; (iii) at T plus two hours, a point in time copy of the primary volume was recorded on region B data protection storage client 108 from the primary volume on data source client 104; (iv) at T plus three hours, a point in time copy of the primary volume was recorded on region C data protection storage client 110 from the primary volume on data source client 104; and (v) at T plus four hours, a point in time copy of the primary volume was recorded on region A data protection storage client 106 from the primary volume on data source client 104.

In the event of one of the three data backup sites experiencing a failure, there is only a one in three chance that it is at the data backup site with the most recent point in time copy, and if so, then the next most recent copy is only one period (in this case, hour) older. In the absence of this technique, if there was only one backup data protection site recording all the point in time copies, there would be a single point of failure for losing the point in time copies to be used in the event of disaster recovery of the primary volume. However, if there were multiple data backup sites each recording point in time copies every period, the amount of storage required would increase linearly for each additional data backup site recording. There would be more sources for a point in time copy recorded at the end of the most recent period, at the cost of significantly more storage.

In some alternative embodiments, other types of copying schemes are used to select which data backup site to use. For example, cycling subsets of data backup sites from a set of data backup sites, where there are N data backup sites available to receive a point in time copy and a subset for a given period includes no more than N−1 data backup sites, such as in a set of ten data backup sites, each period may select cycling pairs of data backup sites for the subset to record a point in time copy. In another example, in a set of ten backup sites available, each period may select nine of the ten available data backup sites for the subset of data backup sites to record point in time copies, cycling which of the ten data backup sites is excluded from recording a point in time copy for the period. In some alternative embodiments, for a target period for taking point in time copies of a target volume, more frequent copies are recorded across the set of data backup sites, where each backup site records at least one point in time copy that is no older than the target period. For example, for a target period of one hour, or hourly point in time copies, across a set of three available data backup sites, a point in time copy is recorded once every 20 minutes, cycling between the three available data backup sites, such that no data backup site records more than one point in time copy within a given hour. In this example, each data backup site has recorded a point in time copy of the target volume that is no more than an hour old.

Processing proceeds to operation S265, where point in time copy storing mod 306 stores a point in time copy on cycling data backup sites. In this simplified embodiment, point in time copy storing mod 306 stores a point in time copy of the primary volume on region B data protection storage client 108, as determined at S260, via TCP/IP connection over network 114. Cycling data backup sites are used, as region B data protection storage client 108 is used for recording the point in time copy of the primary volume for this period, but on region A data protection storage client 106 was used for the previous period and on region C data protection storage client 110 will be used for the next period if it is available for recording.

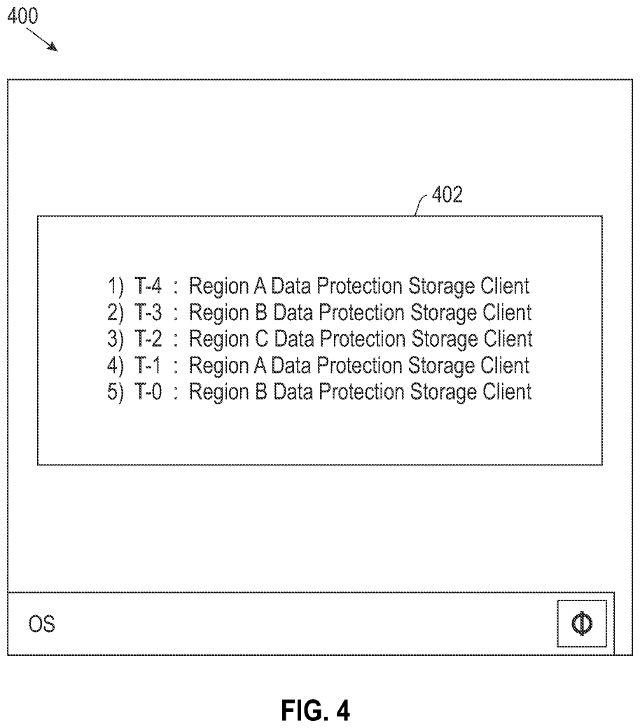

Processing proceeds to operation S270, where point in time copy information broadcasting mod 308 broadcasts point in time copy information among the data backup sites. In this simplified embodiment, point in time copy information is a table listing the history of point in time copies recorded for the primary volume, including which data backup site recorded each point in time copy and when each point in time copy was recorded (such as date and time), shown in message 402 of screenshot 400 of FIG. 4. In some alternative embodiments, other messages are broadcasted including other configurations of information. For example, the times recorded in message 402 might read as data and time stamps (such as 2021/05/25.15:50:00 instead of T-4), or other types of information such as data group, region name, or unique identification information for a given point in time copy.

In some alternative embodiments, data protection distribution subsystems at each of the data protection storage clients (region A, B and C) each schedule instances of operations indicated by flowchart 250 for their respective point in time copying operations, broadcasting to each client metadata for the entire point in time copies taken across a given length of time. Each may schedule instances of operations of flowchart 250 at different intervals, or at similar intervals initiated at different times. For example, the data protection distribution subsystem (not shown) for region A data protection storage client 106 schedules point in time copies to be taken on region A data protection storage client 106 every three hours, beginning at 1:00, the data protection distribution subsystem (not shown) for region B data protection storage client 108 schedules point in time copies to be taken on region B data protection storage client 108 every three hours, beginning at 2:00, and the data protection distribution subsystem (not shown) for region B data protection storage client 110 schedules point in time copies to be taken on region B data protection storage client 110 every three hours, beginning at 3:00. Distributed scheduling in this example results in improved resiliency for performance of the operations illustrated in flowchart 250.

### III. FURTHER COMMENTS AND/OR EMBODIMENTS

Some embodiments of the present invention recognize the following facts, potential problems and/or potential areas for improvement with respect to the current state of the art: (i) more and more, government regulations are encouraging companies to fortify their IT resiliency plans; (ii) not only for unplanned fatal events, but also for the new era of potential cyber-attacks; (iii) disk vendors are equipping their subsystems and software with proper solutions to take regular, frequent, consistent, isolated and protected Point in Time (or PiT) copies of all the production data; (iv) PiT copies are meant to be able to restore the last good copy before the corruption and re-establish the services in the case of logical data corruption; (v) the same concept of cyber protection applies to local or regional environments; (vi) in multi-site and multi-region configurations, two local sites could be maintained continuously in sync via a synchronous mirroring of the data; (vii) while the regional leg is usually asynchronous; (viii) the cyber protection PiT copies can be established in either the local or regional sites or regions; and (ix) there is a problem to be addressed here related to the fact that in the case of unplanned fatal events on the site that contains the PiT consistent copies for protection in case of logical corruption, the enterprise would be potentially exposed to a subsequent Disaster Recovery, but especially to a cyber attack that could logically corrupt or encrypt the data.

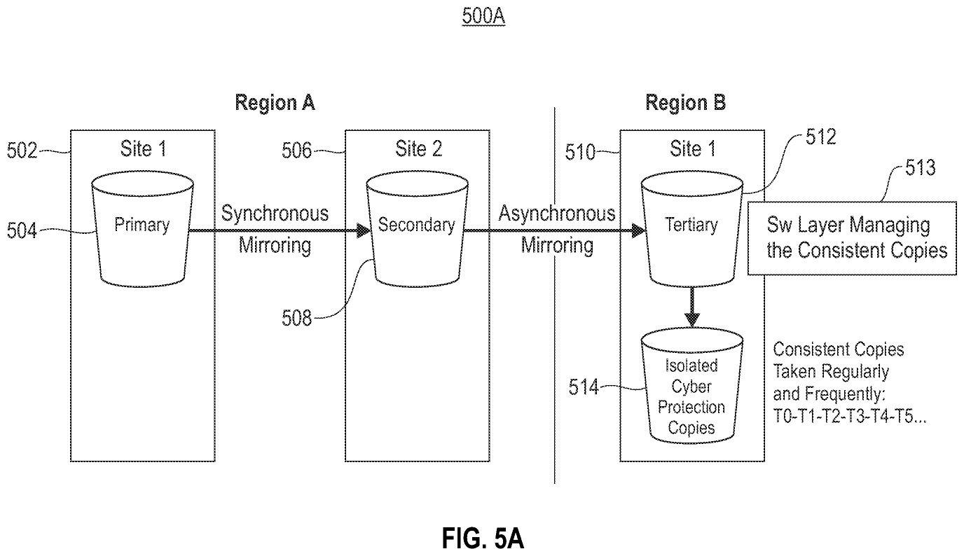

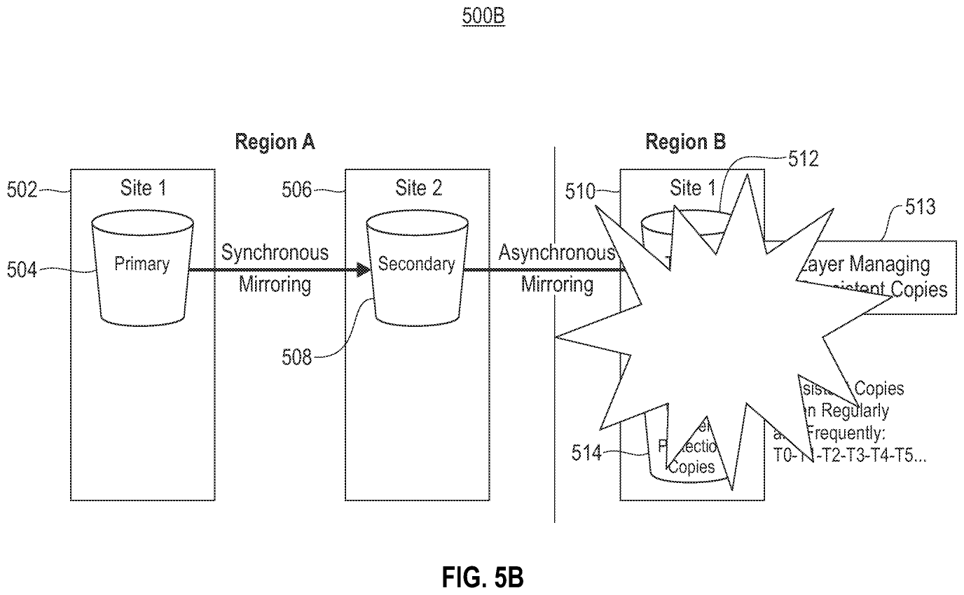

Shown in diagram 500A of FIG. 5A is a typical isolated cyber protection environment according to the state of the art, where region A site 1 502 and region A site 2 506 inhabit the same geographic region, region A, while region B site 1 510 inhabits a second region, region B, which is separated geographically from region A. Region A site 1 further includes primary data copy 504. Region A site 2 includes secondary data copy 508, copied from primary data copy 504 with synchronous mirroring, where the data in each copy is synchronized such that each copy has a complete copy of the data at any given time. Asynchronous mirroring occurs between secondary data copy 508 and tertiary copy 512 of region B site 1 510. Region B site 1 510 also has a software layer for managing consistent copies 513, which stores copies in isolated cyber protection copies 514. Isolated cyber protection copies 514 include point in time copies of secondary data copy 512 (which, as an asynchronous copy of 508, periodically maintains a complete copy of primary data copy 504), taken periodically (such as at T0, T1, T2, etc.) at intervals.

Shown in block diagram 500A of FIG. 5B, if region B site 1 512 is taken offline, disaster recovery protection for primary data copy 504 and secondary data copy 508 is compromised.

Some embodiments of the present invention may include one, or more, of the following operations, features, characteristics and/or advantages: (i) an idea to prevent this exposure is based on a Coordinated Multiple Cyber Protection Repositories and Managers; (ii) basically, provide at least two, possibly more, sites and/or regions with the capability of taking consistent PiT copies of data for cyber protection; (iii) each one with its own software layer of control; (iv) and coordinated with each other; (v) replicating among sites/regions, the consistent PiT backup copies for logical corruption protection would generate additional throughput over the network and could be inconvenient and expensive; (vi) adding a coordinated cyber protection environment instead would distribute the good PiT copies in different locations, without overloading the network or the storage systems, giving more flexibility in case of restore operations; (vii) for example, an enterprise to fulfill its Service Level Agreements, may be required to take protected PiT backup copies of all the data every hour; (viii) instead of doing this in one cyber protected environment, it could take one copy every two hours in two different sites, odd and even hours, managed by a Cyber Protection Manager in each site; (ix) the two Cyber Protection Managers should know each other and exchange information of the backup PiT copies taken; (x) either of them could be used in case of logical data corruption to restore the last good copy; (xi) in the case of loss of one of the two sites, and concomitant or subsequent logical corruption of the active production data, the surviving Cyber Protection Manager and its copies of data would persist in the other site, allowing a recovery that in the worst case could have an older recovery point objective (RPO); and (xii) an additional advantage is that in both sites/regions a data validation process could execute in parallel, speeding up the process and allowing more frequent validation.

Some embodiments of the present invention may include one, or more, of the following operations, features, characteristics and/or advantages: (i) in summary, applying this invention, an environment would gain multiple benefits; (ii) having PiT consistent back-up copies saved in different storage systems repositories distributed in two or more sites and or regions that allows the recovery from a cyber attack also after an unplanned loss of one site; (iii) more frequent PiT copies with a granularity that reduces the RPO in case of recover from a Cyber Attack; (iv) less overhead per storage system and no additional network traffic; (v) global view of all the PiT copies distributed in different sites from all the Cyber Protection Managers; (vi) possibility to choose the best PiT copy to recover from in either repository; (vii) possibility to run data validation process in parallel in more than one Cyber protection environment; (viii) a key point in this solution is to have not only the storage with the consistent copies in at least two of the local or regional sites, but also independent managers responsible for capturing the PiT consistent copies, and each Manager connected each other, in order to exchange the information about which copies with which timestamps are stored where; (ix) each manager must have the full picture of all the PiT backup copies that are available in the whole distributed environment; and (x) with these redundant configurations and connected managers, in case of complete unavailability of one site because of any problem (hardware failure, geographical disaster, data corruption that could also compromise the Manager itself), another instance with good consistent PiT copies and a Manager would be available to coordinate the restore of the latest good PiT copy of data to the production to restore the services.

Some embodiments of the present invention may include one, or more, of the following operations, features, characteristics and/or advantages: (i) the managers must be connected to each other via TCP/IP, to broadcast the information of each backup taken, and to have in any site/region Manager the full list of timestamped copies; (ii) list of requisites: (a) Connected Storage systems with PiT consistent data copy capability in at least two sites, (b) software manager in each site with cyber protection to take the PiT consistent copies, (c) the software managers must have knowledge of each other and broadcast the information about the timestamped PiT backup copies taken, (d) TCP/IP connectivity between the managers below is an example of a view that can be provided from any of the coordinated cyber protection managers with the list of all the PiT backup copies taken in each site/region, with the timestamp; (iii) from this view a user can have a full picture, and if a logical corruption of the data has been identified, they can immediately understand which is the latest good PiT copy and where it is stored; (iv) if the latest good PiT copy is on a storage system that is not accessible, the only way to recover is to restore the latest good copy from the manager in the other location; (v) the RPO will be higher, but without the dual manager there would be no backup available at all; (vi) this solution is also advantageous in relation to the data validation of the PiT backup copies; (vii) to guarantee the goodness of the backup copies a data validation process should ideally be run at every backup, or at least as frequently as possible; (viii) if this is not possible, the validity of the data should be verified when the logical corruption is detected, but this will elongate the RTO of the recovery operations; and (ix) in both cases, periodic validation at backup time, or ad-hoc validation at corruption detection, having multiple coordinated managers and backup repositories would allow you to perform those validations in parallel, speeding up the process to find the last good copy and finally reducing the RTO.

Some embodiments of the present invention may include one, or more, of the following operations, features, characteristics and/or advantages: (i) a resilient Point in Time (PiT) solution that protects users from cyber attacks and outages and allow uninterrupted operations; (ii) create and maintain PiT copies at multiple sites that are part of a synchronous and asynchronous replication solution; (iii) the inventory of PiT copies is distributed to all sites, such that all sites can maintain currency of the PiT copy inventory thus aiding the user when determining which PiT copy in which site to restore following some form of data corruption; (iv) having PiT consistent back-up copies saved in different storage systems repositories distributed in two or more sites and/or regions allows the recovery from a Cyber-attack also after an unplanned loss of one site; (v) “two sites” denotes two location at metropolitan distances where a synchronous mirroring can be used; (vi) “regions” is used when the locations are separated by longer distance with an asynchronous mirroring in between; (vii) removing the single point of failure in case of logical corruption of the data to be able to always restore a copy of the data before the corruption; (viii) the infrastructure is already based on mirrored storage systems, synchronous and asynchronous, but in addition provide several PiT copies at regular time intervals distributed among at least two different sites or regions; (ix) the different sites/regions containing PiT copies are also connected via IP, and they broadcast each other the information about the back-up copies captured, so that everyone has a complete view of all the back-up copies and their consistent time; (x) again, synchronous replication is not protecting against logical corruption; (xi) in addition, if the hardware-based storage systems suffer a failure, the cloud-based one would be vulnerable to a logical corruption, without any protection copy, and vice versa; and (xii) based on mirrored storage systems (synchronous at short and asynchronous at long distance), providing coordinated PiT consistent copies distributed among two or more storage systems located in different site/regions, therefore providing protection against logical corruption also in case of one site/region failure or unavailability.

In some embodiments of the present invention, there is a system for contingency planning, the system comprising: (i) a primary persistent data storage unit located at a first site; (ii) a secondary persistent data storage unit located at a second site and synchronously mirroring the first persistent data storage unit; (iii) a tertiary persistent data storage unit located at a third site and asynchronously mirroring the first persistent data storage unit; (iv) a first isolated contingency unit configured to store point in time (PiT) copies of at least one of the primary or secondary persistent data storage unit; (v) a second isolated contingency unit configured to store point in time copies of at least the tertiary persistent data storage unit; (vi) wherein the first and second isolated contingency units are located at different sites; and (vii) wherein each of the first and second isolated contingency units are connected to a respective manager component, each manager comprising a full list of timestamped copies of the first and second isolated contingency units. The system immediately above further comprising a quaternary persistent data storage unit asynchronously mirroring the tertiary persistent data storage unit and ready to become synchronous to recover the tertiary persistent data storage unit in a case of failure of the primary and secondary persistent data storage units.

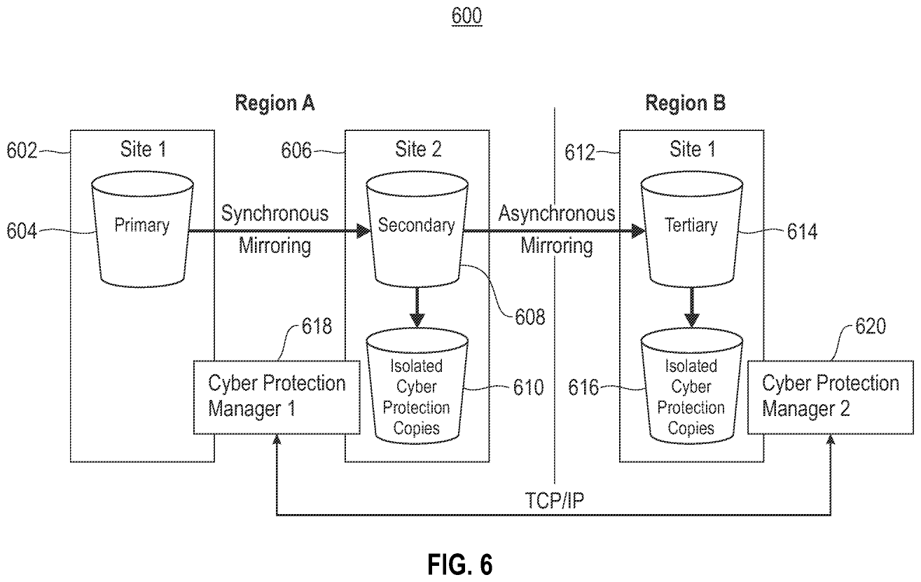

Diagram 600 of FIG. 6 shows a coordinated three site cyber protection system according to a second embodiment of the present invention, including: (i) region A site 1 602; (ii) primary data copy 604; (iii) region A site 2 606; (iv) secondary data copy 608; (v) region A site 2 isolated cyber protection copies 610; (vi) region B site 1 612; (vii) tertiary data copy 614; (viii) region B site 1 isolated cyber protection copies 616; (ix) region A site 1 cyber protection manager 1 618; and (x) region B site 1 cyber protection manager 2 620. Isolated point in time cyber protection copies of the primary data (synchronized with secondary data copy 608) are alternately taken in region A site 2 606 and region B site 1 612. For example, at TO, a point in time copy is stored in region A site 2 isolated cyber protection copies 610, and at T1, a point in time copy is stored in region B site 1 isolated cyber protection copies 616. Region A site 1 cyber protection manager 1 618 and region B site 1 cyber protection manager 2 620 broadcast amongst the sites information about the point in time backup copies (such as their timestamps, to determine which has the most recent point in time backup copy).

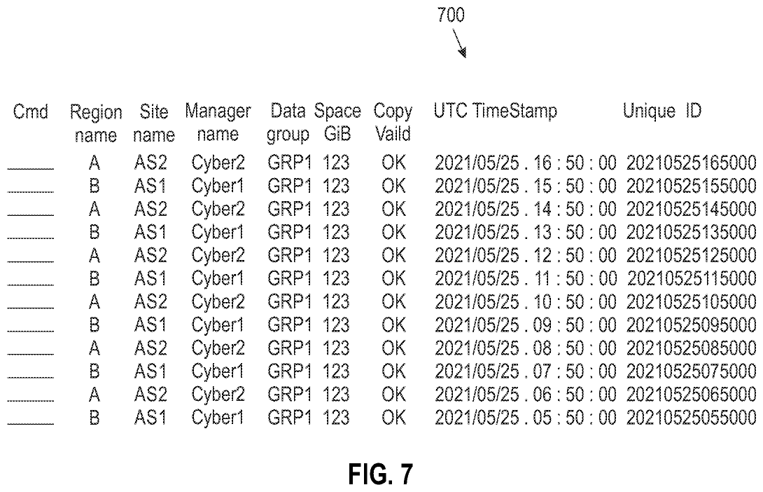

Table 700 of FIG. 7 shows an example of point in time backup copies stored in alternating sites, with the alternating sites in different regions. TCP/IP connectivity between the managers in table 700 is an example of a view that can be provided from any of the coordinated cyber protection managers with the list of all the PiT backup copies taken in each site/region, with the timestamp. From this view a user can have a full picture, and if a logical corruption of the data has been identified, they can immediately understand which is the latest good PiT copy and where it is stored. If the latest good PiT copy is on a storage system that is not accessible, the only way to recover is to restore the latest good copy from the manager in the other location. In this instance, the RPO will be higher, but without the dual manager there would be no backup available at all.

Some embodiments of the present invention may include one, or more, of the following operations, features, characteristics and/or advantages: (i) taking backup copies both in the production metropolitan region, and in the DR region; (ii) having Cyber protected copies in more than one repository isolated each other in term of possible disastrous events; (iii) software managing the copies in each site interconnected via TCP/IP to broadcast the information; (iv) the repositories must be enough separated to be considered isolated, each of them managed by a SW layer that is broadcasting the information to the other managers; (v) allowing multiple TCP/IP interconnected instances of the LCP feature, one in the Metro region, and one in the DR region; (vi) multiple interconnected instances of LCP for GDPS Global GM, that is the asynchronous version of the feature; (vii) four copies (two synchronous, asynchronously mirrored to a DR site, with again two synchronous copies to provide the same level of high availability in case of DR); (viii) mirroring the cyber protected copies would not make sense, and would overload the data links between regions; (ix) independent backup copies would be captured in each repository providing more granularity to recover from a cyber attack in case all the repository are available; (x) or at least the frequency of the one surviving in case of an additional unplanned event; (xi) for example, take one backup copy every odd hour in the production data center and one every even hour in my DR data center; and (xii) in case of cyber attack, recover with a max RPO of one hour if both the data centers are available, or with a max RPO of two hours in the worst case of an unplanned outage of one of the two.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above — similar cautions apply to the term “embodiment.”

and/or: inclusive or; for example, A, B “and/or” C means that at least one of A or B or C is true and applicable.

In an Including / include / includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, and application-specific integrated circuit (ASIC) based devices.

We: this document may use the word “we,” and this should be generally be understood, in most instances, as a pronoun style usage representing “machine logic of a computer system,” or the like; for example, “we processed the data” should be understood, unless context indicates otherwise, as “machine logic of a computer system processed the data”; unless context affirmatively indicates otherwise, “we,” as used herein, is typically not a reference to any specific human individuals or, indeed, and human individuals at all (but rather a computer system).

What is claimed is:

1. A computer-implemented method (CIM) comprising:
monitoring a volume at a first data storage site for periodic point in time copying, where periodic point in time copying includes recording snapshots of the volume at specified times separated by a specified period of time; and
periodically storing a point in time copy of the volume within data storage repositories of a subset of backup data storage site(s) selected from a set of backup data storage sites, where the set of backup data storage sites includes at least two backup data storage sites and the subset selected for storing the point in time copy is selected each period from a cycle of subsets of the set of backup data storage sites.

2. The CIM of claim 1, further comprising:
outputting, to at least the set of backup data storage sites, a point in time copy information dataset corresponding to point in time copy events.

3. The CIM of claim 2, wherein point in time copy information dataset includes a table with entries for point in time copies recorded on the set of backup data storage sites, where each entry in the table includes information indicative of: (i) a timestamp indicating a date and time when a snapshot of the monitored volume was recorded as a given point in time copy, and (ii) what backup data storage site(s) recorded the given point in time copy.

4. The CIM of claim 2, wherein the point in time copy information dataset is outputted among backup data storage sites through TCP/IP connections.

5. The CIM of claim 1, wherein:
the set of backup data storage sites includes at least three backup storage sites; and
there are at least three subsets of backup data storage site(s), with each subset including a unique combination of at least two of the backup data storage sites of the set of backup data storage sites but fewer than the entire set of backup data storage sites, where each backup data storage site records a complete point in time copy of the monitored volume for a given period.

6. The CIM of claim 1, wherein at least one backup data storage site is isolated from the first data storage site and located in a different geographic region than the first data storage site separated by at least ten kilometers.

7. A computer program product (CPP) comprising:
a machine readable storage device; and
computer code stored on the non-transitory machine readable storage device, with the computer code including instructions for causing a processor(s) set to perform operations including the following:
monitoring a volume at a first data storage site for periodic point in time copying, where periodic point in time copying includes recording snapshots of the volume at specified times separated by a specified period of time, and
periodically storing a point in time copy of the volume within data storage repositories of a subset of backup data storage site(s) selected from a set of backup data storage sites, where the set of backup data storage sites includes at least two backup data storage sites and the subset selected for storing the point in time copy is selected each period from a cycle of subsets of the set of backup data storage sites.

8. The CPP of claim 7, wherein the computer code further includes instructions for causing the processor(s) set to perform the following operations:
outputting, to at least the set of backup data storage sites, a point in time copy information dataset corresponding to point in time copy events.

9. The CPP of claim 8, wherein point in time copy information dataset includes a table with entries for point in time copies recorded on the set of backup data storage sites, where each entry in the table includes information indicative of: (i) a timestamp indicating a date and time when a snapshot of the monitored volume was recorded as a given point in time copy, and (ii) what backup data storage site(s) recorded the given point in time copy.

10. The CPP of claim 8, wherein the point in time copy information dataset is outputted among backup data storage sites through TCP/IP connections.

11. The CPP of claim 7, wherein:
the set of backup data storage sites includes at least three backup storage sites; and
there are at least three subsets of backup data storage site(s), with each subset including a unique combination of at least two of the backup data storage sites of the set of backup data storage sites but fewer than the entire set of backup data storage sites, where each backup data storage site records a complete point in time copy of the monitored volume for a given period.

12. The CPP of claim 7, wherein at least one backup data storage site is isolated from the first data storage site and located in a different geographic region than the first data storage site separated by at least ten kilometers.

13. A computer system (CS) comprising:
a processor(s) set;
a machine readable storage device; and
computer code stored on the machine readable storage device, with the computer code including instructions for causing the processor(s) set to perform operations including the following:
monitoring a volume at a first data storage site for periodic point in time copying, where periodic point in time copying includes recording snapshots of the volume at specified times separated by a specified period of time, and
periodically storing a point in time copy of the volume within data storage repositories of a subset of backup data storage site(s) selected from a set of backup data storage sites, where the set of backup data storage sites includes at least two backup data storage sites and the subset selected for storing the point in time copy is selected each period from a cycle of subsets of the set of backup data storage sites.

14. The CS of claim 13, wherein the computer code further includes instructions for causing the processor(s) set to perform the following operations:
outputting, to at least the set of backup data storage sites, a point in time copy information dataset corresponding to point in time copy events.

15. The CS of claim 14, wherein point in time copy information dataset includes a table with entries for point in time copies recorded on the set of backup data storage sites, where each entry in the table includes information indicative of: (i) a timestamp indicating a date and time when a snapshot of the monitored volume was recorded as a given point in time copy, and (ii) what backup data storage site(s) recorded the given point in time copy.

16. The CS of claim 14, wherein the point in time copy information dataset is outputted among backup data storage sites through TCP/IP connections.

17. The CS of claim 13, wherein:
the set of backup data storage sites includes at least three backup storage sites; and
there are at least three subsets of backup data storage site(s), with each subset including a unique combination of at least two of the backup data storage sites of the set of backup data storage sites but fewer than the entire set of backup data storage sites, where each backup data storage site records a complete point in time copy of the monitored volume for a given period.

18. The CS of claim 13, wherein at least one backup data storage site is isolated from the first data storage site and located in a different geographic region than the first data storage site separated by at least ten kilometers.

19. A computer-implemented method (CIM) comprising:
mirroring at least one data volume(s) to a set of data protection sites; and
coordinating the set of data protection sites to record isolated copies of the mirrored at least one data volume(s), where data protection sites record isolated copies of the at least one data volume(s) from their local mirror of the at least one data volume(s) according to their respective schedules.

20. The CIM of claim 19, wherein:
there are at least two subsets of data protection sites; and
each subset of data protection sites has a corresponding schedule for recording isolated copies of the mirrored at least one data volume(s) which is unique from other subsets of data protection sites such that each subset of data protection sites records isolated copies at different times than other subsets of data protection sites.

21. The CIM of claim 19, wherein each data protection site broadcasts isolated copy metadata datasets to at least some of the other data protection sites in the set of data protection sites, where the metadata datasets include information indicative of timestamps corresponding to when isolated copies were recorded and their respective data protection sites where the isolated copies are recorded.

22. The CIM of claim 21, wherein coordinating the set of data protection sites further includes:
receiving instructions to initiate recovery operations for the at least one data volume(s);
determining which data protection sites of the set of data protection sites are currently operational;
determining, from the currently operational data protection sites, which data protection site hosts an isolated copy of the at least one data volume(s) recorded most recently prior to a target date and time based, at least in part on the metadata datasets; and
instructing the determined data protection site to output the isolated copy of the at least one data volume(s) recorded most recently prior to the target date and time to at least some of currently operational data protection sites.

23. A computer-implemented method (CIM) comprising:
receiving, by a backup data site, a metadata dataset including information corresponding to a plurality of isolated backup copies of a data volume distributed among a plurality of coordinated backup data sites, where the metadata dataset includes information indicative of when each isolated backup copy was recorded and which coordinated backup data site recorded each isolated copy;
receiving, by the backup data site, a copy of the data volume according to a set of mirroring protocols;
receiving, by the backup data site, a schedule for isolated copy operations for the data volume;
recording, by the backup data site, isolated copies of the data volume according to the received schedule; and
responsive to recording an isolated copy of the data volume according to the received schedule, broadcasting, by the backup data site, an updated metadata dataset to at least some of the coordinated backup data sites, with the updated metadata dataset including the received metadata dataset with additional information indicative of when the isolated copy was recorded and a corresponding location for the isolated copy indicative of data storage associated with the backup data site.

24. The CIM of claim 23, further comprising:
receiving, by the backup data site, a notification indicative of initiation of recovery operations for the data volume;
determining, by the backup data site, an isolated copy in the backup data site as a target recovery copy for restoring the data volume based, at least in part, on the updated metadata dataset.

25. The CIM of claim 24, further comprising:
outputting, by the backup data site, the target recovery copy to at least some of the coordinated backup data sites.
